(19) United States
(12) Patent Application Publication
(10) Pub. No.: US 2014/0217851 A1
(43) Pub. Date: Aug. 7, 2014

(54) ELECTRIC MACHINE AND A METHOD OF CONSTRUCTING A COMMUTATOR FOR AN ELECTRIC MACHINE

(71) Applicant: REMY TECHNOLOGIES, L.L.C., Pendleton, IN (US)

(72) Inventor: Michael D. Bradfield, Anderson, IN (US)

(73) Assignee: REMY TECHNOLOGIES, L.L.C., Pendleton, IN (US)

(21) Appl. No.: 13/759,501

(22) Filed: Feb. 5, 2013

(51) Int. Cl. H02K 15/00; H02K 13/00

(52) U.S. Cl. CPC H02K 15/00; H02K 13/006
USPC 310/235; 310/236; 29/597

(57) ABSTRACT

An electric machine and a method of forming a commutator for an electric machine includes forming a commutator assembly including a plurality of commutator bar members linked through a corresponding plurality of bridge elements, rolling the commutator assembly into a commutator form having a substantially continuous, uninterrupted, outer surface, introducing an internal support member that receives an end portion of each of the plurality of commutator bar members into an inner diameter of the commutator form, and separating the plurality of commutator bar members by removing each of the plurality of bridge elements creating a discontinuous outer surface.

### BACKGROUND OF THE INVENTION

Exemplary embodiments pertain to the art of electric machines and, more particularly, to a method of constructing a commutator for an electric machine and an electric machine having a commutator constructed in accordance with the method.

Many electric machines include a housing that supports a stator or field. An armature is arranged in the housing and rotates relative to the field. Generally, the armature includes a shaft that supports a commutator and a plurality of armature windings. The commutator is electrically connected to a plurality of armature windings. The commutator is connected to terminals on the housing through a set of brushes. The brushes ride on, and are in electrical contact with, an outer surface of the commutator. Typically, a spring biases the brushes onto the commutator to maintain the electrical contact.

A commutator typically includes a set of individual contact bars fixed to the rotating shaft of a machine. In a motor, the electrical current flowing through the armature windings via the commutator and brushes interact with a stationary magnetic field produced in the field coil. The interaction of the current and stationary field produces a magnetic force that, in turn, produces a torque on the armature. The torque causes the armature to rotate about an axis defined by the shaft. In a generator, a mechanical torque applied to the shaft creates a motion of the armature windings through the field. Movement of the armature windings in the field induces a voltage that is passed through the commutator to the terminals via the brushes.

### BRIEF DESCRIPTION OF THE INVENTION

Disclosed is a method of constructing a commutator for an electric machine. The method includes forming a commutator assembly including a plurality of commutator bar members linked through a corresponding plurality of bridge elements, rolling the commutator assembly into a commutator form having a substantially continuous, uninterrupted, outer surface, introducing an internal support member that receives an end portion of each of the plurality of commutator bar members into an inner diameter of the commutator form, and separating the plurality of commutator bar members by removing each of the plurality of bridge elements creating a discontinuous outer surface.

Also disclosed is an electric machine including an armature having a commutator constructed by a method including forming a commutator assembly including a plurality of commutator bar members linked through a corresponding plurality of bridge elements, rolling the commutator assembly into a commutator form having a substantially continuous, uninterrupted, outer surface, introducing an internal support member that receives an end portion of each of the plurality of commutator bar members into an inner diameter of the commutator form, and separating the plurality of commutator bar members by removing each of the plurality of bridge elements creating a discontinuous outer surface.

### BRIEF DESCRIPTION OF THE DRAWINGS

The following descriptions should not be considered limiting in any way. With reference to the accompanying drawings, like elements are numbered alike:

FIG. 1 depicts an electric machine including an armature having a commutator constructed in accordance with an exemplary embodiment;

FIG. 2 depicts a commutator assembly including a plurality of commutator bar members joined by a plurality of bridge elements in accordance with an exemplary embodiment;

FIG. 3 depicts the armature assembly of FIG. 2 rolled into a commutator form;

FIG. 4 depicts the armature assembly of FIG. 3 with support rings installed in accordance with an exemplary embodiment;

FIG. 5 depicts the armature assembly of FIG. 4 with the internal support member installed;

FIG. 6 depicts the armature assembly of FIG. 5 following removal of bridge elements joining the plurality of commutator bar members;

FIG. 7 depicts the armature assembly of FIG. 6 following formation of a riser at an axial end thereof; and

FIG. 8 is a perspective view of the commutator constructed in accordance with the method of the exemplary embodiments.

### DETAILED DESCRIPTION OF THE INVENTION

A detailed description of one or more embodiments of the disclosed apparatus and method are presented herein by way of exemplification and not limitation with reference to the Figures.

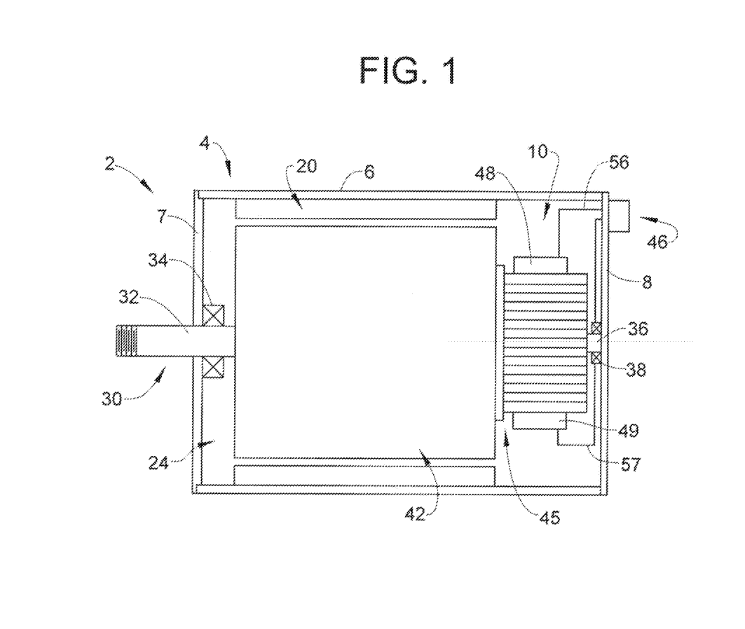

An electric machine in accordance with an exemplary embodiment is indicated generally at 2 in FIG. 1. Electric machine 2 includes a housing 4 having a first wall 6, a second wall 7 and a third wall 8. First, second and third walls 6-8 are connected and form an interior region 10 that houses a field 20 and an armature assembly 24. Field 20 is mounted to an internal surface (not separately labeled) of first wall 6. Armature assembly 24 is rotatably mounted relative to field 20. Armature assembly 24 includes a shaft 30 having a first end 32 rotatably supported at second wall 7 through a first bearing 34 and a second end 36 rotatably supported at third wall 8 by a second bearing 38. An armature winding assembly 42 is fixedly mounted to shaft 30.

Armature winding assembly 42 may include one or more windings or poles that are rotated relative to field 20. Armature assembly 24 also includes a commutator 45 that is electrically connected to armature winding assembly 42 and a terminal block 46. More specifically, commutator 45 is electrically connected to terminal block 46 through first and second brushes 48 and 49 via corresponding first and second conductors 56 and 57. At this point it should be understood that while armature assembly 24 is described as being fixedly mounted to shaft 30, shaft 30 may be fixedly mounted to housing 4 and armature assembly 24 may be rotatably mounted thereupon. Further, it should be understood that the number of brushes electrically connected to commutator 45 may vary.

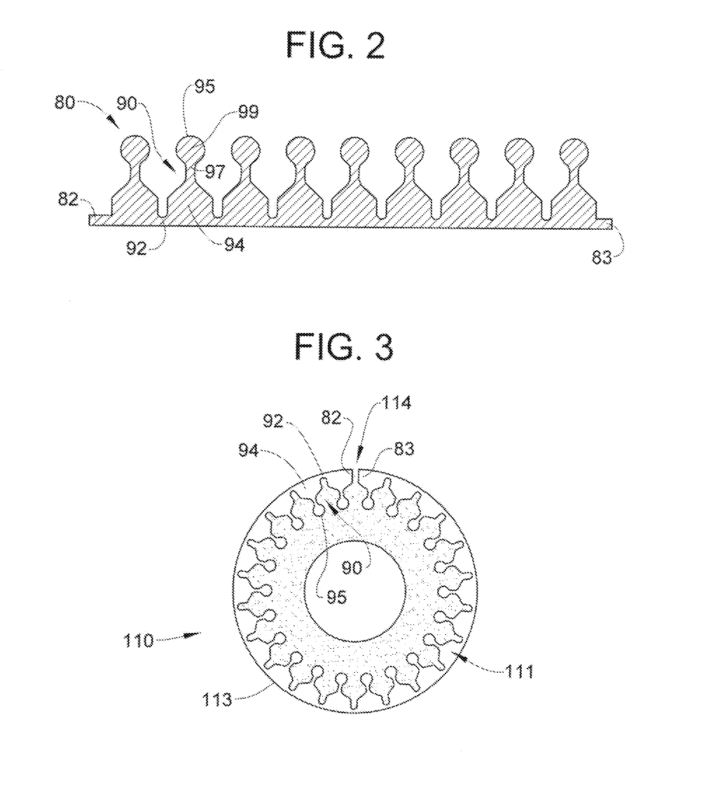

In accordance with an exemplary embodiment, commutator 45 is formed from a one-piece commutator assembly 80 illustrated in FIG. 2. One-piece commutator assembly 80 extends from a first end portion 82 to a second end portion 83 and includes a plurality of commutator bar members, one of which is indicated at 90. Commutator bar members 90 are linked through a plurality of bridge elements, one of each is indicated at 92. Each commutator bar member 90 includes a first end portion 94, a second end portion 95 and an intermediate portion 97. Second end portion 95 has a generally circular cross-section 99 while intermediate portion 97 includes a reduced thickness. More specifically, intermediate portion 97 has a thickness that is less than a thickness of first end portion 94 and a thickness of second end portion 95.

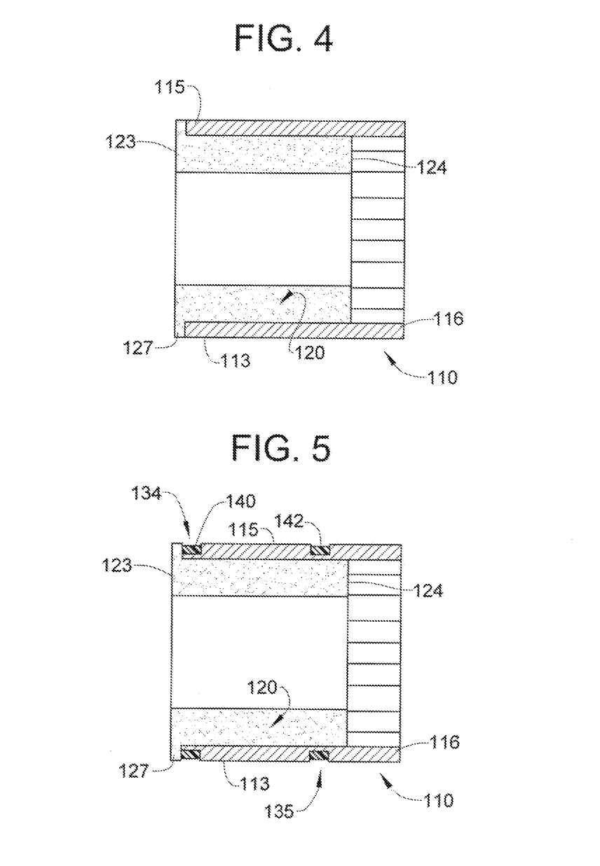

In accordance with an exemplary embodiment, one-piece commutator assembly 80 is formed into a commutator form 110 having a generally circular cross-section 111 and a substantially continuous outer surface 113 as shown in FIG. 3. Commutator form 110 does possess a discontinuity 114 in substantially continuous outer surface 113 at a region in which first end portion 82 and second end portion 83 come together. Commutator form 110 includes a first axial end 115 and an opposing second axial end 116. Commutator form 110 is provided with an internal support member 120 as shown in FIG. 4.

Internal support member 120 may be injection molded into commutator form 110 about intermediate portions 97, second end portions 95 and a section of first end portions 94 of commutator bar members 90. Internal support member 120 provides support to commutator bar members 90. Internal support member 120 also physically locates each commutator bar member 90 relative to others of commutator bar members 90. Internal support member 120 extends from a first end section 123, that is positioned at first axial end 115, to a second end section 124. Second end section 124 is spaced from second axial end 116. First end section 123 may be provided with a circumferential flange 127. Internal support member 120 provides electrical isolation between the plurality of commutator bar members 90 upon the removal of bridge elements 92, as will be discussed more fully below. Internal support member 120 also provides electrical isolation between the plurality of commutator bar members 90 and shaft 30 once commutator 45 is mounted to armature assembly 24.

As seen in FIG. 5, a first circumferential notch 134 is formed in substantially continuous outer surface 113 of commutator form 110 at first axial end 115. A second circumferential notch 135 is formed in substantially continuous outer surface 113 between first axial end 115 and second axial end 116. Each circumferential notch 134 and 135 has a fixed depth. The fixed depth may extend through each of the plurality of bridge elements 92 creating a localized discontinuity in substantially continuous outer surface 113. The fixed depth does not however extend entirely through each of the plurality of commutator bar members 90. A first fiberglass tape 140 is wrapped around commutator form 110 in first circumferential notch 134. A second fiberglass tape 142 is wrapped around commutator form 110 in second circumferential notch 135. First and second fiberglass tapes 140 and 142 provide radial support to commutator bars 90 when commutator 45 is subjected to centrifugal forces.

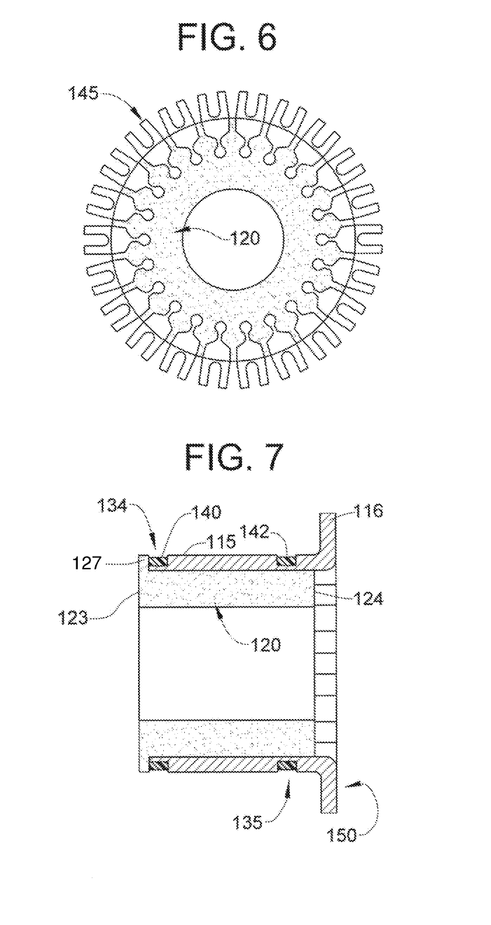

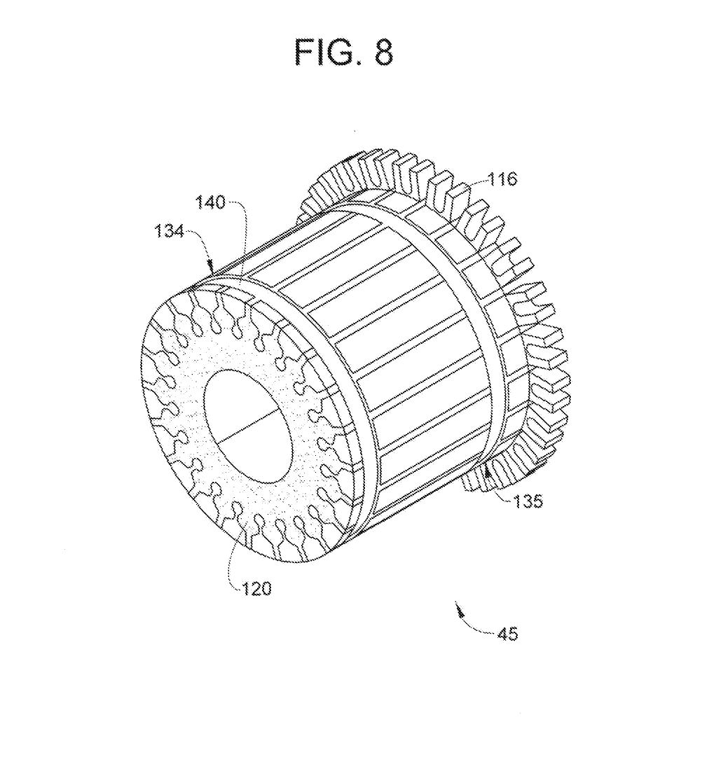

As shown in FIG. 6, a plurality of slots, one of which is indicated at 145 is formed in commutator form 110. Slots 145 are formed in first end portions 94 of corresponding ones of the plurality of commutator bar members 90. In addition to forming slots 145, each bridge element 92 is removed to physically separate each of the plurality of commutator bar members 90. Once separated, second axial end 116 is folded, or bent, at a substantially right angle to form a riser 150 as shown in FIG. 7. Once riser 150 is formed, commutator 45 takes on an appearance as shown in FIG. 8. At this point, commutator 45 may be mounted on shaft 30 to form part of armature assembly 24. When commutator 45 is installed on shaft 30, riser 150 abuts armature winding assembly 42.

At this point it should be understood that the exemplary embodiments describe a method of constructing a commutator from a one-piece commutator assembly. More specifically, in place of the more labor intensive process of loading individual commutator bars into a fixture, joining the commutator bars and shaping the commutator bars, the exemplary embodiment employs a one-piece commutator assembly that simplifies the construction and manufacture of a commutator. It should also be understood that the one-piece commutator assembly can be formed using a variety of techniques including stamping, extrusion and the like. Also, while described as being wrapped with fiberglass tape, other materials may also be employed to wrap the commutator form.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims.

What is claimed is:

1. A method of constructing a commutator for an electric machine, the method comprising:
forming a one-piece commutator assembly including a plurality of commutator bar members linked through a corresponding plurality of bridge elements;
rolling the one-piece commutator assembly into a commutator form having a substantially continuous, uninterrupted, outer surface;
introducing an internal support member that receives an end portion of each of the plurality of commutator bar members into an inner diameter of the commutator form; and
separating the plurality of commutator bar members by removing each of the plurality of bridge elements creating a discontinuous outer surface.

2. The method of claim 1, wherein introducing the internal support includes molding the internal support about the end portion of each of the plurality of commutator bar members.

3. The method of claim 1, further comprising, forming a circumferential notch in the commutator form.

4. The method of claim 3, wherein forming the circumferential notch in the commutator form includes forming the circumferential notch in the substantially continuous, uninterrupted outer surface of the commutator form.

5. The method of claim 4, further comprising: wrapping the commutator form with a fiberglass tape.

6. The method of claim 5, wherein wrapping the commutator form with fiberglass tape includes positioning the fiberglass tape in the circumferential notch.

7. The method of claim 1, further comprising, bending an axial end of each of the plurality of commutator bar members to form a riser.

8. The method of claim 7, wherein bending the axial end of each of the plurality of commutator bar members to form the riser includes forming a substantially right angle bend in the axial end of each of the plurality of commutator bar members.

9. The method of claim 7, further comprising: forming a slot in an end portion of each of the plurality of commutator bar members.

10. The method of claim 9, wherein forming the slot includes forming a slot in the axial end of each of the plurality of commutator bar members.

11. An electric machine including an armature having a commutator constructed by a method comprising:
forming a one-piece commutator assembly including a plurality of commutator bar members linked through a corresponding plurality of bridge elements;
rolling the one-piece commutator assembly into a commutator form having a substantially continuous, uninterrupted, outer surface;
introducing an internal support member that receives an end portion of each of the plurality of commutator bar members into an inner diameter of the commutator form; and
separating the plurality of commutator bar members by removing each of the plurality of bridge elements creating a discontinuous outer surface.

12. The electric machine according to claim 11, wherein introducing the internal support includes molding the internal support about the end portion of each of the plurality of commutator bar members.

13. The electric machine according to claim 11, further comprising, forming a circumferential notch in the commutator form.

14. The electric machine according to claim 13, wherein forming the circumferential notch in the commutator form includes forming the circumferential notch in the substantially continuous, uninterrupted outer surface of the commutator form.

15. The electric machine according to claim 14, further comprising: wrapping the commutator form with a fiberglass tape.

16. The electric machine according to claim 15, wherein wrapping the commutator form with fiberglass tape includes positioning the fiberglass tape in the circumferential notch.

17. The electric machine according to claim 11, further comprising, bending an axial end of each of the plurality of commutator bar members to form a riser.

18. The electric machine according to claim 17, wherein bending the axial end of each of the plurality of commutator bar members to form the riser includes forming a substantially right angle bend in the axial end of each of the plurality of commutator bar members.

19. The electric machine according to claim 17, further comprising: forming a slot in an end portion of each of the plurality of commutator bar members.

20. The electric machine according to claim 19, wherein forming the slot includes forming the slot in the axial end of each of the plurality of commutator bar members.
